(19) United States
(12) Patent Application Publication
(10) Pub. No.: US 2011/0126556 A1
(43) Pub. Date: Jun. 2, 2011

(54) COOLING SYSTEM FOR HYBRID VEHICLE AND CONTROL METHOD THEREOF

(75) Inventors: Taehun Jung, Seoul (KR); Seungho Mok, Suwon (KR); Jungho Lee, Hwaseong (KR)

(73) Assignee: HYUNDAI MOTOR COMPANY, Seoul (KR)

(21) Appl. No.: 12/879,370

(22) Filed: Sep. 10, 2010

(30) Foreign Application Priority Data
Dec. 1, 2009 (KR) 10-2009-0118011

(51) Int. Cl. B60H 1/32

(52) U.S. Cl. 62/61; 62/133

(57) ABSTRACT

The present invention features a cooling system for a hybrid vehicle. The present invention makes it possible to minimize the increase of the cost of a vehicle and improve the cooling performance of the hybrid vehicle without an electric compressor, by allowing the hybrid vehicle to ensure an available cooling time as long as possible in the ISG mode.

### CROSS-REFERENCE TO RELATED APPLICATIONS

The present application claims under 35 U.S.C. §119(a) priority to Korean Patent Application Number 10-2009-0118011, filed Dec. 1, 2009, the entire contents of which application is incorporated herein for all purposes by this reference.

### BACKGROUND OF THE INVENTION

1. Field of the Invention

The present invention relates, in general, to a cooling system for a hybrid vehicle and a control method thereof. In particular, the present invention related to a technology for improving the cooling performance under an Idle Stop-Go (ISG) state in a hybrid vehicle without a specific electric compressor.

2. Description of Related Art

Hybrid vehicles have an advantage of saving fuel consumed in the idle state by stopping the engine, and by using an ISG (Idle Stop-Go) mode when waiting for the signal.

However, since the compressor does not operate for cooling in the idle stop state, a measure is required to ensure appropriate cooling performance in the idle stop state.

Although recent research has been directed to an ISG vehicle that can continuously perform cooling using a battery even if the engine stops, by using an electric compressor, there are cost and technical considerations.

Therefore, it is increasingly required to minimize reduction of cooling performance while maintaining the current system equipped with a mechanical compressor driven by the engine, without an electric compressor. Further, methods to keep the engine operating under poor cooling conditions and methods to determine automatic restart conditions from external temperature and evaporator temperature have only been developed up to now.

Accordingly, there remains a need in the art for improved cooling systems for hybrid vehicles.

The information disclosed in this Background of the Invention section is only for enhancement of understanding of the general background of the invention and should not be taken as an acknowledgement or any form of suggestion that this information forms the prior art already known to a person skilled in the art.

### SUMMARY OF THE INVENTION

In preferred aspects, the present invention provides a cooling system for a hybrid vehicle that can suitably minimize the increase of the cost of a vehicle and suitably improve the cooling performance of the hybrid vehicle without an electric compressor, by allowing the hybrid vehicle to ensure an available cooling time as long as possible in the ISG mode. The present invention also features a method of controlling the cooling system.

In preferred embodiments, the present invention provides a cooling system for a hybrid vehicle, which preferably includes a valve assembly that is provided to isolate an evaporator from a throttle valve and a compressor by controlling coolant flowing into/out of the evaporator, and a controller that suitably isolates the evaporator from the throttle valve and the compressor by controlling the valve assembly in accordance with cooling conditions in idle stop.

Another preferred embodiment of the present invention provides a method of controlling the cooling system, which preferably includes stopping flow of the coolant from the throttle valve to the evaporator by closing the first solenoid valve in the idle stop; and normalizing a cooling circuit that opens the first solenoid valve, when the idle stop is suitably removed.

Another preferred embodiment of the present invention provides a method of controlling the cooling system, which preferably includes, circulating some cooing air passing through evaporator by stopping flow of coolant from the throttle valve to the evaporator by closing the first solenoid valve and opening the second solenoid valve in the idle stop; and suitably preventing the cooling air passing through the evaporator from flowing through the bypass channel by normalizing the cooling circuit that opens the first solenoid valve, and suitably closing the second solenoid valve, when the idle stop is suitably removed.

According to preferred embodiments, the present invention makes it possible to suitably minimize the increase of the cost of a vehicle and improve the cooling performance of the hybrid vehicle without an electric compressor, by allowing the hybrid vehicle to suitably ensure an available cooling time as long as possible in the ISG mode.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIGS. 1 and 2 are views illustrating a cooling system for a hybrid vehicle according to the present invention.

FIG. 3 is a flowchart illustrating an embodiment of a method of controlling a cooling system for a hybrid vehicle according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION OF THE INVENTION

As described herein, the present invention features a cooling system for a hybrid vehicle, comprising a valve assembly, and a controller.

In a preferred aspect, the present invention features a cooling system for a hybrid vehicle, comprising a valve assembly that is provided to isolate an evaporator from a throttle valve and a compressor by controlling coolant flowing into/out of the evaporator, and a controller that isolates the evaporator from the throttle valve and the compressor by controlling the valve assembly in accordance with cooling conditions in idle stop.

In a preferred embodiment, the valve assembly includes a first solenoid valve that is provided to stop flow of the coolant between the throttle valve and the evaporator and controlled by the controller, and a check valve that is disposed between the evaporator and the compressor and stops flow of the coolant from the compressor to the evaporator.

In another further preferred embodiment, the cooling system for a hybrid vehicle further comprises a bypass channel that connects the rear of the evaporator with the front of a blower in an air duct, and a second solenoid valve that opens/closes the bypass channel in accordance with cooling conditions in the idle stop by the control of the controller.

In another aspect, the present invention features a method of controlling the cooling system of a hybrid vehicle, the method comprising stopping flow of the coolant from the throttle valve to the evaporator, and normalizing a cooling circuit that opens a first solenoid valve, when the idle stop is removed.

In one embodiment, stopping flow of the coolant from the throttle valve to the evaporator is carried out by closing the first solenoid valve in the idle stop.

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

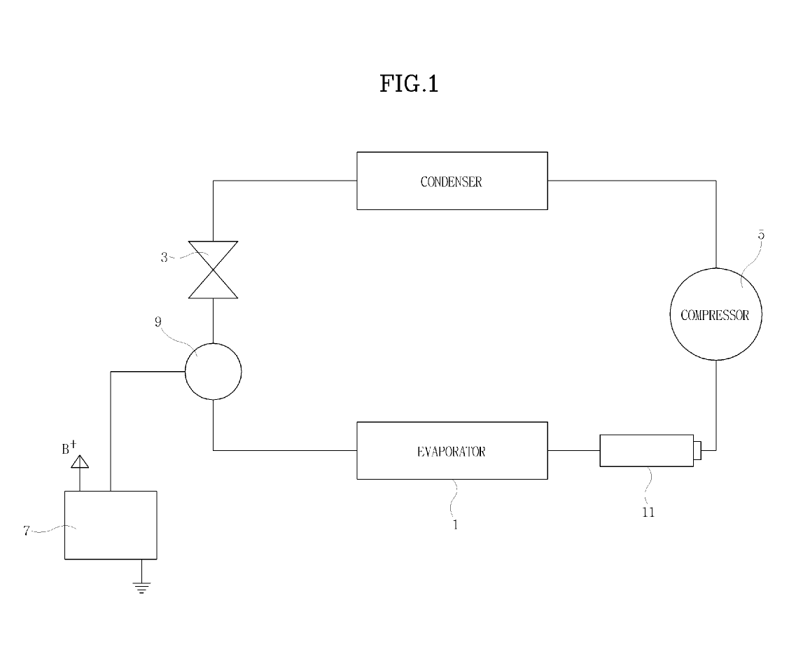

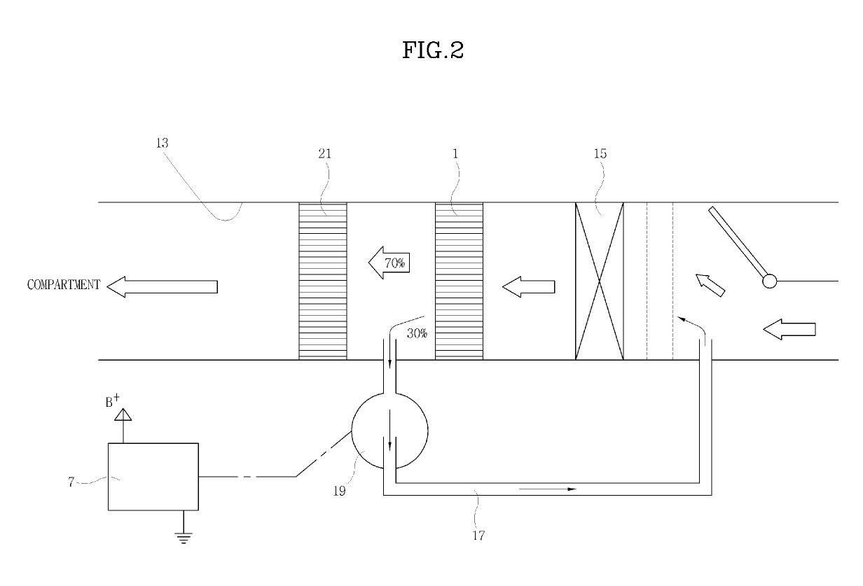

According to certain preferred embodiments referring to FIGS. 1 and 2, for example, a cooling system for a hybrid vehicle according to an embodiment of the present invention preferably includes a valve assembly that is provided to isolate an evaporator 1 from a throttle valve 3 and a compressor 5 by controlling coolant flowing into/out of evaporator 1; and a controller 7 that isolates evaporator 1 from throttle valve 3 and compressor 5 by controlling the valve assembly in accordance with cooling conditions in idle stop.

According to certain preferred embodiments, the valve assembly includes a first solenoid valve 9 that is suitably provided to stop flow of the coolant between throttle valve 3 and evaporator 1 and controlled by controller 7, and a check valve 11 that is suitably disposed between evaporator 1 and compressor 5 and stops flow of the coolant from compressor 5 to evaporator 1.

According to certain preferred embodiments, instead of check valve 11, a specific solenoid valve can be used to be opened/closed by controller 7, but the flow of the coolant from evaporator 1 to compressor 5 between evaporator 1 and compressor 5 does not influence the increase of temperature of evaporator 1, such that it is possible to suitably achieve the same effect while reducing the cost, by disposing check valve 11 that can stop only the flow of the coolant from compressor 5 to evaporator 1 while allowing only the flow of the coolant from evaporator 1 to compressor 5 and influencing the increase of temperature of evaporator 1.

According to further preferred embodiments, the present invention preferably includes a bypass channel 17 that suitably connects the rear of evaporator 1 with the front of a blower 15 in an air duct 13 and a second solenoid valve 19 that suitably opens/closes bypass channel 17 in accordance with cooling conditions in the idle stop by the control of controller 7.

For example, according to certain exemplary embodiments, and as shown in FIG. 2, the air sent to blower 15 flows into the vehicle compartment through evaporator 1 and a heater core 21, and in this process, some of the cooling air passing through evaporator 1 is circulated to the front of blower 15 by bypass channel 17 and second solenoid valve 19, such that it can contribute to increase the available cooling time in the idle stop where the cooling performance is bad.

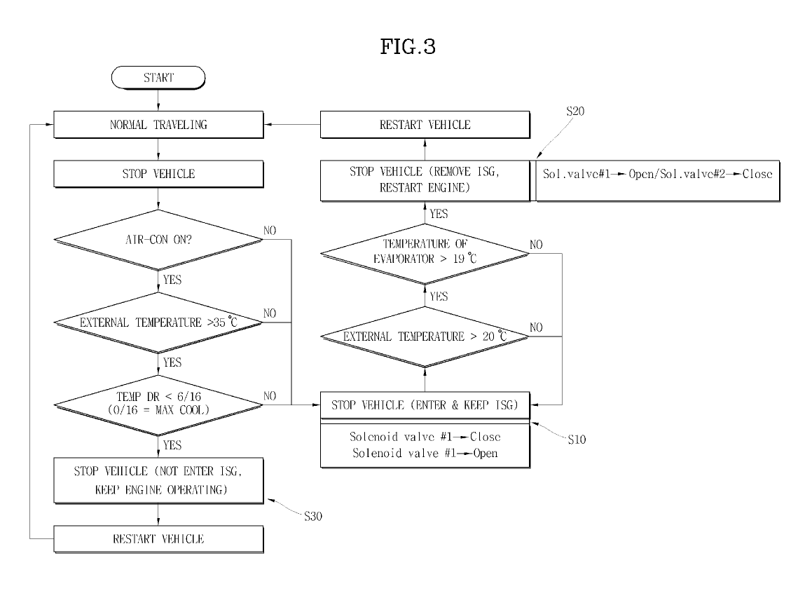

In further preferred embodiments of the present invention, in a method of controlling the cooling system, for example, as exemplified in FIG. 3, preferably includes circulating some of cooing air passing through evaporator 1 by stopping flow of coolant from throttle valve 3 to evaporator 1 by closing first solenoid valve 9 and opening second solenoid valve 19 in the idle stop (S10); and suitably preventing the cooling air passing through evaporator 1 from flowing through bypass channel 17 by normalizing the cooling circuit that opens first solenoid valve 9, and closing second solenoid valve 19, when the idle stop is removed (S20).

In further exemplary embodiments, it may be possible to remove second solenoid valve 19 and bypass channel 17, in which in the idle stop, the method preferably includes preventing the coolant from flowing into evaporator 1 from throttle valve 3 by closing first solenoid valve 9 and normalizing the cooling circuit that opens first solenoid valve 9 when the idle stop is removed, in order to control the cooing system.

According to further preferred embodiments, control when both bypass channel 17 and second solenoid valve 19 as shown, for example, in FIG. 2 are provided is described hereafter with reference to FIG. 3.

According to certain exemplary embodiments and as shown in the flowchart in FIG. 3, the operation of the engine is kept without entering the idle stop even if the vehicle stops, when the external temperature is too high and excessive cooling is required (S30), first solenoid valve 9 and second solenoid valve 19 are closed and opened, respectively, while the vehicle enters the idle stop in other cases (S10), and the idle stop is suitably removed by restarting the engine and first solenoid valve 9 and second solenoid valve 19 are suitably opened and closed, respectively, to the initial states, when the external temperature and the temperature of evaporator 1 become higher than predetermined temperature, even if the idle stop is specifically removed (S20).

Accordingly, when the vehicle stops and the air-con operates as a result of determining whether the air-con operates, and when the external temperature is suitably higher than 35° C. and the temp-door is suitably less than the sixth level in the total sixteen levels, the vehicle does not enter the idle stop state by keep the engine operating (S30), and when any one of the air-con, the external temperature, and the temp-door states is not suitably satisfied, the vehicle enters the idle stop by stopping the engine (S20).

For reference, temp-door reflects the operational state of the cooling system by the passenger and the 0 level means the maximum cooling.

Further, according to preferred embodiments of the present invention, when the vehicle enters the idle stop, evaporator 1 is isolated by closing first solenoid valve 9 such that the temperature of evaporator 1 is not suitably increased by the coolant supplied from throttle valve 3 or compressor 5 and the cooling performance is ensured as long as possible. In further preferred embodiments, the time that the evaporator 1 takes to suitably increase in temperature is maximally delayed by opening second solenoid valve 19 such that some of the cold air cooled through evaporator 1 circulates to the front of blower 15 through bypass channel 17, and accordingly, it is available for cooling performance as long as possible in the idle stop (S10).

Preferably, when the external temperature is above 20° C. and the temperature of evaporator 1 is above 19° C. in the control described above, it is difficult to achieve appropriate cooling without operating the compressor 5, such that it is required to normally operate the air-con by restarting the engine, even if the vehicle is in stop.

According to further preferred embodiments, in this operation, the first solenoid valve 9 is suitably opened and the second solenoid valve 19 is suitably closed such that the original air-con coolant cycle is appropriately performed (S20).

Preferably, in this configuration, the external temperature and the temperature of evaporator 1 for removing the idle stop is not limited to 20° C. and 19° C., and may be modified at appropriate levels, if needed.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cooling system for a hybrid vehicle, comprising:
a valve assembly that is provided to isolate an evaporator from a throttle valve and a compressor by controlling coolant flowing into/out of the evaporator; and
a controller that isolates the evaporator from the throttle valve and the compressor by controlling the valve assembly in accordance with cooling conditions in idle stop.

2. The cooling system for a hybrid vehicle as defined in claim 1, wherein the valve assembly includes:
a first solenoid valve that is provided to stop flow of the coolant between the throttle valve and the evaporator and controlled by the controller; and
a check valve that is disposed between the evaporator and the compressor and stops flow of the coolant from the compressor to the evaporator.

3. The cooling system for a hybrid vehicle as defined in claim 2, further comprising:
a bypass channel that connects the rear of the evaporator with the front of a blower in an air duct; and
a second solenoid valve that opens/closes the bypass channel in accordance with cooling conditions in the idle stop by the control of the controller.

4. A method of controlling the cooling system of claim 2, comprising:
stopping flow of the coolant from the throttle valve to the evaporator by closing the first solenoid valve in the idle stop; and
normalizing a cooling circuit that opens the first solenoid valve, when the idle stop is removed.

5. A method of controlling the cooling system of claim 3, comprising:
circulating some of cooing air passing through evaporator by stopping flow of coolant from the throttle valve to the evaporator by closing the first solenoid valve and opening the second solenoid valve in the idle stop; and
preventing the cooling air passing through the evaporator to flow through the bypass channel by normalizing the cooling circuit that opens the first solenoid valve, and closing the second solenoid valve, when the idle stop is removed.

6. The method as defined in claim 5, wherein when the external temperature and the temperature of the evaporator are higher than predetermined temperature after the vehicle enters the idle stop, the idle stop is removed by restarting the engine even if the vehicle is in stop.

7. A method of controlling the cooling system of a hybrid vehicle, the method comprising:
stopping flow of the coolant from the throttle valve to the evaporator; and
normalizing a cooling circuit that opens a first solenoid valve, when the idle stop is removed.

8. The method of controlling the cooling system of a hybrid vehicle of claim 7, wherein stopping flow of the coolant from the throttle valve to the evaporator is carried out by closing the first solenoid valve in the idle stop.
